(19) United States
(12) Patent Application Publication
(10) Pub. No.: US 2003/0091487 A1
(43) Pub. Date: May 15, 2003

(54) Continuous flow heating system

(76) Inventor: Magnus Fagrell, Uppsala (SE)

Correspondence Address: HARNESS, DICKEY & PIERCE, P.L.C., P.O. BOX 8910, RESTON, VA, 20195, US

(21) Appl. No.: 10/270,460

(22) Filed: Oct. 15, 2002

Related U.S. Application Data
(60) Provisional application No. 60/334,983, filed on Oct. 19, 2001.

(51) Int. Cl. G05D 23/00; B01J 19/08

(52) U.S. Cl. 422/198; 422/109; 422/307; 422/186

(57) ABSTRACT

Continuous flow heating system and a method of performing chemical reactions in a process fluid carried out in the system. The system includes fluid transporting and containing means and a number of sections adapted to control the temperature of the process fluid according to a predetermined temperature profile. The system comprises at least one heat-up section provided with a microwave heating means and at least one constant temperature section provided with a heating means, adapted to hold the temperature of the process fluid passing through it at a substantially constant temperature T_{C}.

### FIELD OF THE INVENTION

The present invention relates to a system, a method and the use of the system and the method for carrying out chemical reactions on a continuous basis, particularly applicable for carrying out organic synthesis reactions.

### BACKGROUND OF THE INVENTION

Microwave heating systems for carrying out chemical reactions are known in the field of microwave-assisted chemistry. Microwave heating provides for an increase of the reaction rate of chemical reactions with order of magnitudes. The use of microwaves also usually leads to higher yield and purity of the final product. These systems are implemented, ranging from small laboratory scale up to full production scale, as either batch or continuous flow systems. Generally batch systems are used in small scale and continuous flow systems are preferred, e.g. for safety reasons, in large scale production when tons of chemicals are to be produced per day.

A method and apparatus for carrying out chemical reactions on a continuous basis is disclosed in U.S. Pat. No. 5,387,397. According to this known method a conduit passes through three sections: An inlet section comprising a pump to feed the reactants through the conduit, a microwave section that heats the reactants in the conduit and an effluent section that includes a heat exchanger and pressure control means to cool the reactants immediately after the microwave section and depressurize the heated fluid after it has been cooled.

One of the major disadvantages of the apparatus disclosed in U.S. Pat. No. 5,387,397 is the dependency of the heating rate versus the process temperature and the poor ability to hold a constant predetermined process temperature during a predetermined process time.

The apparatus disclosed in U.S. Pat. No. 5,387,397 has only one heating chamber for both heating up the process fluid to a preset target temperature and holding the same at a constant temperature for a predetermined time. Considering the process parameters:

microwave input power

microwave power utilisation efficiency, which is a function of the process fluid, temperature and the state of the chemical reaction

preset process temperature

time to reach the preset process temperature

hold time at the set process temperature

outlet temperature

pressure;

It is obvious that if one parameter is changed all other parameters will adjust to that change due to dependency of mentioned parameters. Consequently—if one parameter is set at a fixed value all the others must be adjusted to the set parameter.

It is also obvious that the probability of obtaining constant temperature, in the apparatus described in U.S. Pat. No. 5,387,397, from the point in the conduit where the process fluid has reached the preset process temperature to a point in the conduit, e.g. the outlet of the intermediate zone, where the process fluid has been treated for the preset period of time is very low. Moreover, the apparatus disclosed in U.S. Pat. No. 5,387,397 has an obvious drawback in the fact that if the outlet temperature or any other temperature is set to a constant value the heating rate is thereby set and limited to the power required to maintain the set temperature. This power is in most cases far from optimal, often substantially lower than desired in terms of heating rate and will result in a much longer heat-up time than desired, which will prolong the overall process time and considerably increase the risk of forming unwanted by products.

The object of the present invention is to achieve a system and a method that solve the above-mentioned problems.

### SUMMARY OF THE INVENTION

The above-mentioned object is achieved by the present invention as defined in the independent claims.

Preferred embodiments are set forth in the dependent claims.

It is often desirable to run a chemical reaction at a desired constant temperature during a predetermined period of time, after an initial temperature increase from the start condition. It is also desirable to have a short heat-up time so that the set process temperature is quickly attained. This is in order to minimise any side reactions, by-products or degradation of the formed product occur due to too high or too low temperature in the processed fluid during any appreciable time. Too high or too low temperature can also lead to lower product yield.

Thus, by the system and the method according to the claimed invention are provided chemical reactions resulting in products with improved yield and purity.

The system according to the present invention comprises several sections where each section has only one main function. The sections and their function may mainly be:

a heat-up section 4 adapted to heat the process fluid passing through it from an initial input temperature to a predetermined increased output temperature,

a constant temperature section 10 adapted to hold the process fluid passing through it at a predetermined constant temperature, i.e., the input and the output temperature in this section will substantially be the same, for a predetermined time, and

a cooling section 16 adapted to cool the process fluid to a desired lower temperature.

The above-mentioned sections may be arranged in any order and number to form a continuous flow system that provides for the desired temperature profile that a certain chemical reaction requires, provided that a heat-up section is always the first section in the system preceding any other section.

The heat-up section may further be divided into smaller subsections. The constant temperature section may also further be divided into smaller sub-sections to ensure a constant temperature along the whole constant temperature zone.

The different important process parameters mentioned herein that are necessary to control in order to achieve a predetermined temperature profile for a desired chemical reaction, may be controlled in each section or subsection of the continuous flow system or anywhere else along the system. The controlling means, which may involve any known suitable controlling method or technique, may be connected to a computer in order to communicate, generate and store pre-programmed temperature profiles and other useful parameters for controlling purposes. The controlling means may also via the computer or directly receive external signals from e.g. pumps, valves etc. for controlling purposes.

A successful heating process for chemical reactions depends on the ability to control the time-temperature profile, i.e. to heat the process fluid to the desired temperature within a predetermined time, to hold this temperature constant for a predetermined time and also the possibility to cool down during another predetermined time. Reproducibility and product yield depends on a precise control of the overall time-temperature conditions.

After reaching the desired process temperature, the ability to hold the reached temperature at a constant level depends on, e.g., the applied microwave power, the dielectric and other physical properties of the heated process fluid, the pressure in the process fluid, the physical dimensions and thermal properties of the fluid transporting means and the flow rate of the process fluid.

Another important parameter is the dwell time for a molecule, particle or any arbitrary chosen small volume of the process fluid in the constant temperature zone. By dwell time is meant herein the time a molecule, particle or any arbitrary chosen small volume of the process fluid is actually staying in a section. This is in contrast to hold time, which is the predetermined time set in the control means.

The mean dwell time may be a statistical distribution, e.g. exponential, rectangular or any other type of statistical distribution. The design of the section may be done, such as to obtain as close as possible conformance with the rectangular distribution of the dwell time for any molecule or particle in the process fluid. In a rectangular distribution any molecule, particle or any arbitrary chosen small volume of the process fluid in the constant temperature, zone has substantially the same dwell time. For example this may be achieved by two pistons, which are moving in phase at each end of the fluid transporting means 2 shown in FIG. 2. This may result in a very even flow throughout all sections providing that all sections have approximately the same diameter. This is a so-called “plug-flow” being very close to the ideal rectangular distribution.

The present invention as is defined in the appended claims is particularly suitable for implementing specific temperature profiles. This is due to the system according to the claimed invention where different sections have only one function (e.g. heating, holding a constant temperature and cooling) that may be arranged in any desired manner as described herein.

### SHORT DESCRIPTION OF THE APPENDED DRAWINGS

FIG. 1 shows a block diagram and a graph illustrating the present invention.

FIG. 2 shows a schematic illustration of a preferred embodiment according to the present invention.

### DETAILED DESCRIPTION OF PREFERRED EMBODIMENTS OF THE INVENTION

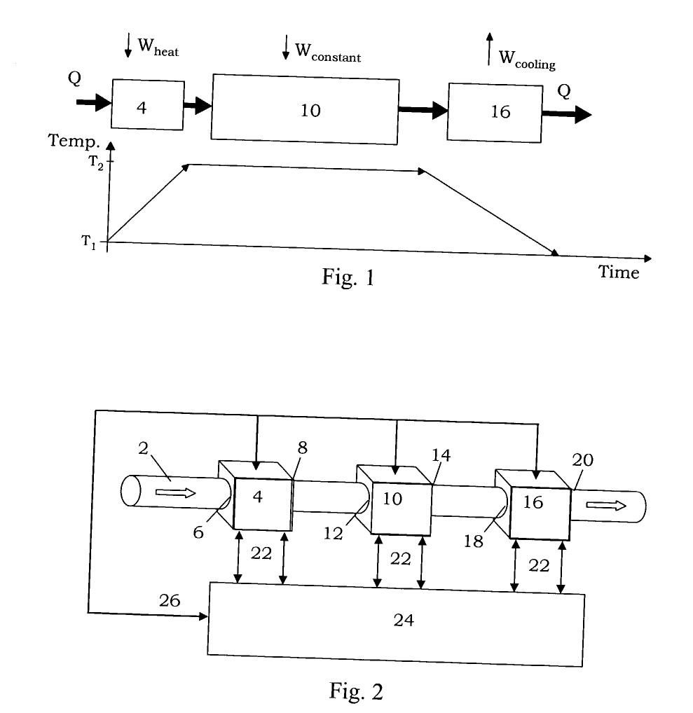

The present invention will now be described in detail with references to both FIGS. 1 and 2.

FIG. 1 shows a block diagram and a graph illustrating the present invention and FIG. 2 shows a schematic illustration of a preferred embodiment of the present invention.

The block diagram of FIG. 1 schematically illustrates a continuous flow heating system for performing chemical reactions in a process fluid flowing in a fluid transporting means, indicated by horizontal arrows in FIG. 1 and by reference sign 2 in FIG. 2, according to a preferred embodiment of the present invention. The continuous flow heating system includes a first heat-up section 4 having an input 6 and an output 8 and provided with a microwave heating means. The heating means is adapted to heat fluid passing through the first heat-up section from an input fluid temperature T₁ to an output fluid temperature T₂.

To level any temperature gradients caused by any uneven field distribution in the microwave heating system, this section may be equipped with stirring means. These stirring means may be either dynamic, i.e. mechanical stirring means, e.g. vanes or impellers that may be magnetically or mechanically controlled and driven, or static, i.e. structures on the inner surface of the fluid transporting means.

The continuous flow heating system includes a first constant temperature section 10 having an input 12 and an output 14 and provided with a heating means. The constant temperature section 10 is adapted to hold the temperature of the process fluid passing through it at a constant temperature T_{C}. Due to the usually longer dwell time in the constant temperature section, relatively to that in the heating-up zone, it is very important to have an internal geometry of the fluid transporting means that supports a uniform axial flow profile of the reaction mixture to achieve, as close as possible, a rectangular distribution of molecules in the process fluid. How to design such geometry is well known to those skilled in the art and is not, therefore, described in detail herein.

In order to promote the chemical transformation it is sometimes necessary to stir the reaction mixture in the constant temperature section. This stirring means may be of the same type as described for the heating-up section hereinabove.

By constant temperature is meant herein a temperature around which the actual temperatures of all sub-volumes of the process fluid in the section is allowed to vary within predetermined limits depending on the chemical process. These predetermined limits may be larger for higher reaction temperatures and smaller for lower reaction temperatures, for example, they may be up to ±10 respectively up to ±5 degrees, other limit values are naturally also possible, e.g., the limit values could be a predetermined percentage of the temperature rise to constant temperature, e.g. 5%.

The constant temperature section 10 is preferably provided with a microwave heating means. Alternatively, the constant temperature section 10 may be provided with a conventional heating means, e.g., by using resistive heating elements or radiation heating elements.

The heat-up and the constant temperature section may share the same microwave source. Alternatively they may individually be provided with separate microwave sources.

The microwave heating means used in the heat-up and constant temperature sections in the system of the invention, may comprise any known microwave applicator of any shape being suitable to the used fluid transporting and containing means and resulting in that the desired heating is achieved.

The graph in FIG. 1 illustrates an exemplary temperature profile to be implemented in the system. In the first part of the graph the temperature of the fluid rises from a lower temperature, indicated as T₁, to a higher temperature, indicated as T₂. These temperature values may be set to any feasible value. T1 is suitably −10 to 35° C., preferably 0 to 35° C. and most preferably 20 to 30° C. T2 is suitably 40 to 350° C., preferably 80 to 300° C. and most preferably 100 to 250° C.

In the next part of the temperature profile illustrated by the graph the temperature is held constant at temperature T_{c} during the time between t₁ and t₂. The temperature T_{c} is typically essentially the same as the output flow temperature T₂.

In the last part of the temperature profile cooling of the process fluid is performed from the constant temperature T_{c} down to a desired lower temperature, e.g. in the interval 20-30° C. or to a temperature of a desired interval below the constant temperature.

The heating rate and the cooling rate may of course also be varied from a more or less instant, very rapid heating/cooling rate (a temperature changing-rate of, e.g., up to 100 K/s) to a very low heating/cooling rate (a temperature changing-rate of, e.g., down to 0,1 K/s).

The increase rate of the temperature in the heating part and the decrease rate of the temperature in the cooling part of the temperature profile depend on many different parameters and factors. Among those may be mentioned the flow rate of the process fluid, i.e., the feed through time in a specific section of the system for a specific process fluid molecule, the dielectric and physical properties of the process fluid, the applied energy, pressure etc.

Although the present invention is illustrated by the temperature profile in FIG. 1, it would be obvious for a person skilled in the art of chemical processing techniques to use other types of temperature profiles applicable for certain chemical reactions. For example may instead of the cooling part illustrated in FIG. 1 the constant temperature part be followed by a second heating part rising the temperature to a desired higher temperature and then followed by a further constant temperature part where that temperature is held constant.

Each part of the temperature profile is represented by a section of the system that is schematically illustrated in FIG. 2. As indicated above, many other combinations of sections are possible, whereas the system illustrated in FIG. 2 is one preferred embodiment of the present invention. In addition to the heat-up section 4 and the constant temperature section 10 a cooling section 16 provided with an input 18 and an output 20 connected to the constant temperature section. The cooling may be achieved by e.g. a heat exchange means (not shown) according to well-established technique or by any other known cooling means suitable for the used process.

The system illustrated in FIG. 2 comprises temperature sensing means arranged to measure the temperature of the fluid in the different sections, e.g., at the inputs and/or outputs of the sections and/or at any other suitable position in the different sections. Thus, for example, one or more temperature sensing means may be arranged in the constant temperature section, in the heating section and/or in the cooling section. The temperature sensing means may be any known means and involve any known suitable temperature sensing technique.

The measured temperature values, generally indicated in the figure by reference sign 22, are applied to a control means 24 adapted to control by a control signal 26 the heat generation/cooling in the sections in dependence of inter alia the measured temperatures and the used temperature profile. For example, the heat generation in the first heating section 4 is controlled so that a predetermined heating rate of the fluid is achieved, suitably in the range of 0.1-100 Kelvin/s, preferably 1-50 Kelvin/s and most preferably 1-20 Kelvin/s.

The system of the invention is preferably, pressurised to a preset pressure required in order for the preset temperature in the system to be reached. The required pressure depends on the physical properties of the process fluid, e.g., its vapour pressure. Thus, apart from temperature sensing means, the system according to the present invention may also comprise pressure sensing means arranged along the system and in connected external equipment such as pumps, valves etc. The thus obtained pressure values may be used, in combination or separate from the temperature values, for controlling the system and/or external devices.

In a further preferred embodiment according to the invention, the system is pressurised only along the heat-up and the constant temperature sections and depressurised after the last constant temperature section.

The fluid transporting means may be a physical structure, such as a conduit, that transports and also may contain the process fluid during its passage through the system. It may be joined together of a number of separate units of the same or different materials, or may be one single unit.

Furthermore, the fluid transporting means along its longitudinal axis may have a straight, circular, helix formed or any other shape adapted for the particular application of the heating system.

According to a preferred embodiment of the present invention, the transporting means may be a single tube in one piece through the whole system. For example, a glass tube with constant diameter and wall thickness may be used as fluid transporting means through all sections, with the heating means being coaxially positioned on the glass tube.

According to a further preferred embodiment of the present invention the fluid transporting means may have different cross-section areas within the different sections of the system. For example, the fluid transporting means may have a cross-section area A₁ in the heat-up section and a cross-section area A₂ in the constant temperature section. Then A₁ and A₂ may optionally be chosen so that A₁ may be greater than, equal to, or less than A₂. Preferably, due to the required much higher power density in the heat-up section, the cross-section area of the fluid transporting means within this section may normally be less than that within the constant temperature section.

In FIG. 1 also the flow in the fluid transporting means is indicated by Q, being the input flow to the heating section 4, the output flow from the constant temperature section 10 and the output flow from the cooling section. Also schematically indicated is the applied energies supplied to the heating section and to the constant temperature section 10 as W_{heating} and W_{constant}, respectively. W_{cooling} indicates, in FIG. 1, the cooling achieved in the cooling section 16.

According to one exemplary embodiment of the preferred embodiment of the present invention, as illustrated by FIGS. 1 and 2, the temperature heating rate is 5 K/s. To raise the temperature to 180° C. then takes about 36 seconds provided that the initial temperature is 0° C. This means that every fluid molecule must be in the heating section in average for 36 seconds. In order to have a reasonable output power of the heating means the volume of the heating section may be limited to less than 500 mL. It is naturally possible to choose virtually any volume. Provided that the fluid transporting means in the heating section 4 has a cross-section area of 1250 (diameter 40 mm) mm² and a flow of 10 ml/s (equals 36 1/h), a linear velocity of the process fluid of 8 mm/s is achieved. The length of the heating section must then be 288 mm.

In order to perform a certain synthesis it is, e.g., required that the fluid has a constant temperature during 300 seconds. The fluid transporting means is arranged, e.g. in the form of a tube, having a length of 2880 mm and the same cross section area as in the heating section. If instead a shorter tube having a length of 500 mm is used it must have a cross section area of 5988 mm².

The present invention also comprises a method, as defined in the appended claims, of performing chemical reactions in a continuous flow heating system as described herein above. The method comprises:

applying a temperature profile representing desired temperature changes of a process fluid passing through the system,

providing a continuous and pressurized feed of process fluid to the inlet of the system,

heating the process fluid passing through a heat-up section from an input temperature T₁ to a desired output temperature T₂, and

holding the process fluid passing through a constant temperature section at a desired constant temperature T_{c} for a desired time.

The method according to the present invention may further comprise cooling the process liquid passing through a cooling section to a desired lower temperature.

The claimed method may further comprise controlling the temperature of the process fluid according to the desired temperature profile by generating control signals that control the heat generation, pressure and/or cooling rate, thus enabling to control the holding of a constant temperature in the constant temperature section.

The process fluid, containing reactant/s, reagent/s or any other required substance for the desired chemical reaction, is fed into the inlet of the system and then forced into the different sections, whereby the reaction products are collected at the outlet of the system. The feeding may be done by any known feeding technique, such as gravimetric feeding, pumping, etc. The process fluid passes the heat-up section 4 and the constant temperature section 10 where the chemical transformation (reaction) takes place. The cooling section 16 is used to cool the process fluid to a desired temperature. The effluent process fluid may be recirculated to the inlet of the system and processed until the desired chemical transformation is achieved. Alternatively, the process fluid may be recirculated between only one or more sections. During any step in the process, reagents and other chemicals, if desired, may be added to, or withdrawn from the process fluid.

The invention also relates to the use of the above-described continuous heating system and the method for carrying out organic chemical synthesis reactions. Chemical reactions that can be carried out by using the hereinabove described system and the method are, for example, oxidation, nucleophilic substitution, addition, esterification, transesterification, acetalisation, transketalisation, amidation, hydrolyses, isomerisation, condensation, decarboxylation and elimination.

The system and the method according to the present invention is suitable for conducting chemical reactions and particularly chemical synthesis reactions, in laboratory scale as well as in large industrial scale.

The present invention is not limited to the above-described preferred embodiments. Various alternatives, modifications and equivalents may be used. Therefore, the above embodiments should not be taken as limiting the scope of the invention, which is defined by the appending claims.

1. Continuous flow heating system, for performing chemical reactions in a process fluid, including fluid transporting and containing means and a number of sections adapted to control the temperature of the process fluid according to a predetermined temperature profile, wherein it comprises at least one heat-up section having a fluid input and a fluid output and provided with a microwave heating means, and at least one constant temperature section having a fluid input and a fluid output and provided with a heating means, adapted to hold the temperature of the process fluid passing through it at a substantially constant temperature T_{C}, whereby the heat-up section precedes the constant temperature section.

2. System according to claim 1, wherein at least one constant temperature section is directly subsequent to at least one heat-up section.

3. System according to claim 1, wherein the constant temperature section is provided with a microwave heating means.

4. System according to claim 1, wherein at least one of the heat-up and/or the constant temperature sections is divided into one or more subsections.

5. System according to claim 1, wherein one or more of the sections and/or the subsections are sharing the same microwave-heating source.

6. System according to claim 1, wherein one or more of the sections and/or the subsections is/are individually provided with a microwave-heating source.

7. System according to claim 1, wherein it further comprises at least one cooling section provided with a cooling means adapted to lower the temperature of the process fluid passing through said cooling section to a predetermined temperature.

8. System according to claim 1, wherein it comprises one or more of the heat-up, constant temperature and optionally the cooling section more than one time, whereby they are arranged in a desired order with the proviso that initially at the beginning of the system a heat-up section always precedes any other section.

9. System according to claim 1, wherein the system is under overpressure through all the sections.

10. System according to claim 1, wherein the system is depressurised after the last constant temperature section and before the final cooling is conducted.

11. Method of performing chemical reactions in a continuous flow heating system according to claim 1, wherein it comprises:
a) applying a temperature profile representing desired temperature changes of a process fluid passing through the system,
b) providing a continuous and pressurized feed of process fluid to the inlet of the system,
c) heating the process fluid passing through a heat-up section from an input temperature T₁ to a desired output temperature T₂, and
d) holding the process fluid passing through a constant temperature section at a desired constant temperature T_{C} for a desired time.

12. Method according to claim 11, wherein it further comprises:
e) cooling the process liquid passing through a cooling section to a desired lower temperature.

13. Method according to claim 11, wherein the process fluid remains pressurised at least during step c) and d).

14. Method according to claim 11, wherein the process fluid is pressurised also during step e).

15. Method according to claim 11, wherein the process fluid is being depressurised before step e) is conducted.

16. Method according to claim 11, wherein it further comprises:
f) controlling the temperature of the process fluid according to the desired temperature profile by generating control signals that control the heat generation, pressure and/or cooling rate of the sections in the system, enabling to control the holding of the temperature at a constant temperature in the constant temperature section.

17. Method according to claim 11, wherein step c) precedes steps d) and e).

18. Method according to claim 11, wherein step c) precedes step d) and step d) precedes step e).

19. Method according to claim 8, wherein step d) is directly subsequent to step c), whereby the output temperature in step c) is substantially the same as the constant temperature in step d).

20. Method according to claim 11, wherein steps c), d) and optionally e) are repeated one or more times in any order, provided that initially at starting, step c) precedes steps d) and/or e).

21. Use of a continuous heating system according to claim 1 for performing organic chemical synthesis reactions.

22. Use of a method according to claim 11 for performing organic chemical synthesis reactions.
